(19) United States
(12) Patent Application Publication
(10) Pub. No.: US 2011/0032088 A1
(43) Pub. Date: Feb. 10, 2011

(54) METHOD OF ENCODING HAPTIC INFORMATION ON IMAGE, METHOD OF DECODING HAPTIC INFORMATION FROM IMAGE AND APPARATUS OF PROCESSING HAPTIC INFORMATION FOR THE SAME

(75) Inventors: Seung-Chan KIM, Daejeon (KR); Ki-Uk Kyung, Daejeon (KR); Dong-Soo Kwon, Daejeon (KR); Jun-Seok Park, Daejeon (KR)

Correspondence Address: AMPACC Law Group, PLLC, 6100 219th Street SW, Suite 580, Mountlake Terrace, WA, 98043, US

(73) Assignees: Electronics and Telecommunications Research Institute, Daejeon (KR); Korea Advanced Institute of Science and Technology, Daejeon (KR)

(21) Appl. No.: 12/853,464

(22) Filed: Aug. 10, 2010

(30) Foreign Application Priority Data
Aug. 10, 2009 (KR) 10-2009-0073254
Apr. 22, 2010 (KR) 10-2010-0037380

(51) Int. Cl. G06K 9/36; G08B 6/00

(52) U.S. Cl. 340/407.1; 382/232; 382/233; 382/166

(57) ABSTRACT

Disclosed is a technology of encoding haptic information on images or decoding haptic information from images. The method of encoding the haptic information on the images according to the present invention includes: generating haptic information; generating encoding target data by using the haptic information and header information associated with the haptic information; and generating an encoded image by encoding the encoding target data by using a least significant bit (LSB) of byte data of each of the original image pixels. As a result, the present invention can simply encode/decode the haptic information while maintaining an original image format.

### CROSS REFERENCE TO RELATED APPLICATIONS

This application claims priority to Korean Patent Application No. 10-2009-0073254 filed on Aug. 10, 2009 and Korean Patent Application No. 10-2010-0037380 filed on Apr. 22, 2010, the entire contents of which are herein incorporated by reference.

### BACKGROUND OF THE INVENTION

1. Field of the Invention

The present invention relates to a method of encoding and decoding haptic information and more specifically, to a technology of encoding/decoding haptic information including haptic information of original images.

2. Description of the Related Art

Generally, haptic information is information corresponding to tactile sensation felt by a person's fingertip when touching objects. Tactile sensation is a comprehensive concept of tactile feedback felt when skin touches a surface of an object or kinesthetic force feedback felt when a motion of an articulation or a muscle is hindered.

Korean Unexamined Publication No. 10-2008-0032316 discloses “a graphic-to-tactile production method of a surface using image information.”

The patent discloses a method of generating tactile information using gray scale information (shadow information) of images. This technology converts images into gray scale and immediately generates the tactile information using the images converted into gray scale. This technology can transfer the realistic haptic feedback information matching the images and has been actually used in many applications using tactile information.

However, the haptic information extraction according to the existing method properly determines tactile information according to the targeted images. Further, since the existing haptic information storing method is a method that uses meta data or involves images (gray scale image, etc.) differently from the original images, there are problems in that it is inconvenience to transmit and store the haptic data and it is not easy to manage the haptic data.

Korean Unexamined Publication No. 10-2007-0105770 discloses “a processing system of sensory data and method thereof.” However, the patent is a method that multiplexes and transfers smell, taste, and tactile data into a realistic multimedia file differently from the original images. Therefore, the related art degrades compatibility utilizing data involving the haptic data that includes sensory information provided to the user but transferred through a separate output format.

Therefore, an urgent need exists for a method of encoding/decoding new haptic information capable of effectively transmitting/receiving the haptic information while minimizing damage of original images.

### SUMMARY OF THE INVENTION

In order to solve the above problems, it is an object of the present invention to transmit/receive independent haptic information by transmitting/receiving images having no change in data amount or change in format without requiring separate additional information such as meta files.

It is another object of the present invention to encode haptic information while minimizing damage to the original images due to haptic information encoding by only changing the least significant bit (LSB) of byte data of each pixel of original images.

It is still another object of the present invention to input additional haptic information while minimizing damage to the original image by maximally reducing data amount within a range by appropriately downsizing the encoded haptic information such that it cannot be differentiated by a user.

In order to achieve the above objects, a method of encoding haptic information on images including: generating haptic information; generating encoding target data by using the haptic information illation and header information associated with the haptic information; and generating an encoded image by encoding the encoding target data by using the least significant bits (LSBs) of each byte data of each of the original image pixels.

The haptic information may be haptic distribution data of any one of depth distribution information including protrusion information, impedance information of a surface, texture distribution information, and temperature distribution information, all of which are spatially distributed.

The generating the haptic information may include a downsizing process of reducing a data size to generate the haptic information.

The haptic information may be time series vibration information. In this case, the time series vibration information means the vibration information changed over time.

The generating the encoded image ma insert each bit oldie encoding target data into the least significant bit of byte data of each of some pixels of the original image pixels and may originally maintain the least significant bits of the byte data of the remaining pixels of the original image pixels. The byte data of each of the original image pixels are any one of R, G, and B sub-pixel bytes and non-color data.

When the original image is an animated gif file, the encoding target data is encoded in each image frame.

Further, a method of decoding haptic information from images according to one embodiment of the present invention includes: loading an encoded image; extracting each of the least significant bits (LSBs) of byte data of each of some pixels of the encoded image to recover header information associated with haptic information, and collecting the least significant bits of byte data of the determined number of pixels by using the header information among the remaining pixels of the encoded image to recover the haptic information.

In this case, the extracting the header information loads byte data corresponding to each of a predetermined number of pixels to extract the least significant bits of the loaded byte data and recover the header information by using the extracted bits.

The byte data of each of the original image pixels are any one of R, G, and B sub-pixel bytes and non-color data.

Further, an apparatus of processing haptic information according to one embodiment of the present invention includes: a haptic information generator that generates haptic information; a header generator that is associated with the haptic information and configures encoding target data together with the haptic information; and an encoder that encodes the encoding target data by using the least significant bits (LSBs) of each byte data of each of the pixels of the original images to generate an encoded image.

Further, an apparatus of processing haptic information includes: an image loading unit that loads an encoded image; a header recovering unit that extracts least significant bits (LSBs) of each byte data of some pixels of the encoded image to recover header information associated with haptic information; and a haptic information recovering unit that collects the least significant bits of byte data of the determined number of pixels by using the header information to recover the haptic information.

The present invention can transmit/receive the haptic information by transmitting/receiving images having no the change in the data amount or in format without requiring separate additional information such as the meta files.

Further, the present invention can encode the haptic information while minimizing the damage to the original images due to haptic information encoding by only changing the least significant bit (LSB) of byte data of each pixel of the original images.

Further, the present invention can minimize the damage to the original images by maximally reducing the data amount within a range by appropriately downsizing the encoded haptic information such that it cannot be differentiated by the user.

### BRIEF DESCRIPTION OF THE DRAWINGS

FIG. 1 is a diagram showing one example of haptic data including distribution information according to one embodiment of the present invention;

FIG. 2 is a diagram showing images downsizing haptic distribution data shown in FIG. 1;

FIG. 3 is a diagram showing the least significant bit (LSB) of byte data of each pixel of the original images and each bit of encoded target data when the first character of a header portion of C is ‘6’;

FIG. 4 is a diagram showing change in image pixels according to a method of encoding haptic information according to one embodiment of the present invention;

FIG. 5 is a diagram showing a cursor for haptic interaction;

FIG. 6 is a diagram for explaining haptic distribution information and haptic interaction of a cursor;

FIG. 7 is a diagram showing one example of haptic feedback presenting apparatus using a haptic arm;

FIG. 8 is a diagram shown an example of haption information having values changing over time;

FIG. 9 is a diagram showing an example of encoded target data when “250_{—}22_{—}2” is used as a header and the haptic information of an example shown in FIG. 8 is encoded;

FIG. 10 is an operational flow chart showing a method of encoding haptic information on images according to one embodiment of the present invention;

FIG. 11 is an operational flow chart showing a method of decoding haptic information from images according to one embodiment of the present invention;

FIG. 12 is a block diagram of an apparatus of processing haptic information according to one embodiment of the present invention; and

FIG. 13 is a block diagram of an apparatus of processing haptic information according to another embodiment of the present invention.

### DETAILED DESCRIPTION OF THE PREFERRED EMBODIMENTS

The present invention will be described in detail below with reference to the accompanying drawings. Herein, the detailed description of a related known function or configuration that may make the purpose of the present invention unnecessarily ambiguous in describing the present invention will be omitted Exemplary embodiments of the present invention are provided so that those skilled in the art may more completely understand the present invention. Accordingly, the shape, the size, etc., of elements in the figures may be exaggerated for explicit comprehension.

Hereinafter, exemplary embodiments according to the present invention will be described in detail with reference, to the accompanying drawings.

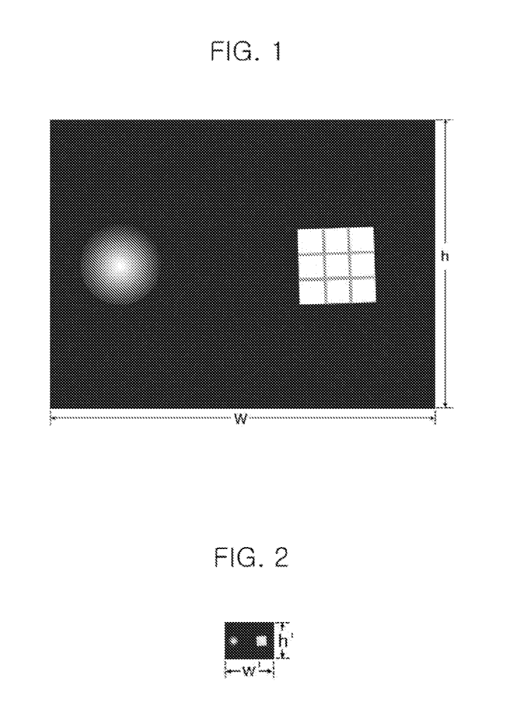

FIG. 1 is a diagram showing one example of haptic data including distribution information according to one embodiment of the present invention.

Referring to FIG. 1, it can be appreciated that haptic distribution data on a 2-dimensional space is represented in a gray scale image form.

The haptic information may have a distribution form UH responding to images. In this case, the haptic information can be considered as a set of step values corresponding to each pixel of images as images.

In addition, the value of the haptic information can be changed over time. In this case, the haptic information can be considered as a series of information listed over time.

The haptic distribution data means that the images have visually distributed color information and are tactilely and spatially distributed. The haptic distribution data has 2-dimensional distribution information and specific step values, such that it can be represented by the gray scale images as shown in FIG. 1. However, the gray scale images are not visually displayed to the user but are used to generate haptic information.

Describing an example of the depth distribution data among the haptic distribution data, it can be appreciated that the larger the respective gray scale value that can be obtained at a position corresponding to each pixel of the image represented in a two-dimensional space, the larger the protrusion becomes. In other words, as the region approaches to white color in FIG. 1, it is protruded to be close to the user, but as the region approaches to black color, it may not be protruded.

A circle and a square shown in FIG. 1 represent the depth distribution data of a hemispherical object and a hexagonal shape, which are put on each plane.

Both the hemispherical object and the hexagonal object have height information. Sometimes, this height information can be confirmed through a shadow, etc.

The image shown in FIG. 1 may be derived from the images used in a PC environment having extensions such as jpg, gif, bmp, png, tif, etc.

In particular, in the example shown in FIG. 1, the square may be the depth information showing a cube puzzle. Therefore, it can be appreciated that there is a square lattice shape.

The depth distribution data may be determined using a software program by comparing photographs taken at a predetermined spatial interval and may be generated by special equipment such as stereo camera, etc. Of course, the depth distribution data can be generated/edited by the user.

According to the embodiment, when the haptic distribution data represent warming distribution, they may be determined, by an infrared camera and when the haptic distribution data represent texture distribution or impedance distribution, they may be determined by a sensor measuring surface region characteristics.

FIG. 2 is a diagram showing images downsizing haptic distribution data shown in FIG. 1.

Referring to FIG. 2, the images shown in FIG. 2 corresponds to results obtained by downsizing the width (w) and height (h) of the image shown in FIG. 1, respectively, by the factor a (0<a<1). Therefore, w′ is equal to w×a and h′ is equal to h×a.

The images shown in FIG. 2 are not visually displayed to the user and can be used only to generate haptic information.

The reason for downsizing the haptic distribution data is to encode the original images by reducing the size of the haptic distribution data and is to minimize the change in the original image data by maximally reducing data to be encoded. This uses the fact that tactile resolution is lower than visual resolution when a person is cognizant of spatially distributed tactile sensation. In other words, the size of the haptic distribution data can be reduced in consideration of cognitive capability.

As described above, the downsized haptic information is again capsized in a decoder, such that it is used to provide the haptic feedback for the original images. Therefore, the resolution of the haptic information can be reduced as much as the downsizing haptic information and the encoded data amount can be reduced as much as the reduction in resolution.

The method of encoding the haptic information on the images according to one embodiment of the present invention will be schematically described below.

When the original image is an image obtained by photographing the hemispherical object and the hexagonal cube puzzle from above, which are put on a desk, the depth distribution data corresponding to the original images can be generated and the depth distribution data may have, a height value corresponding to breadth×width coordinates of the original images.

Before the generated depth distribution data are encoded on the original images, the size of the depth distribution data should be controlled (downsized) as described above, which may correspond to a process of considering the depth distribution data as one image and reducing it at the same ratio in terms of breadth and width.

In other words, the downsizing process of the depth distribution data may be a process of multiplying the size of images by a (0<a<1).

As described above, when the downsized haptic distribution data, obtained by multiplying the size of the depth distribution data by a, are encoded on the original image, it is difficult to visually identify the difference between the original image and the encoded image. The user may use the encoded image including the haptic distribution data for verifying visual information in the existing platform and, if necessary, recover the haptic distribution data in the image form by decoding the downsized haptic distribution data and upsizing the downsized haptic distribution data by the factor 1/a. Since the haptic distribution data are downsized before being encoded, they are again upsized at the time of decoding, such that the resolution of the haptic distribution data is more deteriorated than that of the original images. However, as described above, “a” is appropriately set within a range of the human haptic recognition ability to prevent the distortion of the haptic information. This is similar to an mp3 technology that reduces the information of the region that cannot be perceived by the hearing of a person, in terms of reducing data beyond the cognitive capability of at person.

Hereinafter, the method of encoding haptic information on images according to the present invention will be described with reference to the case of the spatially distributed haptic information. The example of the spatially distributed haptic information may include depth distribution information including protrusion information, impedance information of a surface, texture distribution information, or temperature distribution information, etc.

When the haptic distribution information is represented as images having the step value as shown in FIG. 1, it can be appreciated that the width w and height h of images shown in FIG. 1 are the same as the width w and height h of the original image. When the haptic distribution information is downsized as shown in FIG. 2, the width and height of the image of the downsized haptic distribution information becomes w′(w′=aw) and h′(h′=ah).

Actually, since the encoded haptic distribution information is the downsized haptic distribution information, the header data describes the haptic data with the included information of ‘w’ and ‘h’ and the number of channels. This header data is used in the decoding process to recover the 2-dimensional haptic distribution data from the images.

For example, the header may include the sort and size of haptic information, the information on the number of channels, etc.

For example, the width of the original image is 640 pixels, the height thereof is 480 pixels and when a is set to 1/10, the number of channels of map data is set to 1, and the identifier between the values is set to ‘_’, the header may have the same as “64_{—}48_{—}1.” In addition, in describing the characteristics of haptic information, when ‘01’ is allocated in the case of the depth distribution information, ‘02’ is allocated, in the case of the texture distribution information, and ‘03’ is allocated in the case of the temperature distribution information, the header corresponding to the depth distribution information may have “64_{—}48_{—}1_{—}01_{—}1” corresponding to the depth distribution information as in an embodiment shown in FIG. 1.

When the header information is represented by a binary number, since an ASCII code value of ‘6’ is 54 as a decimal number, it becomes 00110110 as a binary number. In the same manner, the list of binary number values of the exemplified header values is as follows (‘_’ is encoded by “01011111”).

00110110001101000101111100110100001110000101111100110001010111 11 001100000011000101011111

When data for each pixel of the haptic distribution data having the width w′ and height h′ of the determined image form is formed into one array, the values are determined as the set of 0 or 1. When the set of determined bits is defined by B and the header values in the determined binary number form is defined by A, the final form of the binarized encoding data is defined by C, which is a concatenation of A and B sets.

Next, a process of comparing the binarized encoding data with the least significant bit of each pixel of a series of images and changing the pixel values according to the results will be described.

When the C has i bits, each bit of C is sequentially compared from the least significant bit (LSB) of the byte data of the first pixel of the original image that has in (m>i) bytes of the pixel.

In this case, each of the pixels of the original image may be formed of three sub-pixel bytes such as R, G, and C and ma include non-color data such as alpha, Z or bump data, etc., according to the embodiments. Therefore, in the present invention, the byte data may be an R sub-pixel byte, a 0 sub-pixel byte, or a B sub-pixel byte, all of which are included in the pixel and may be the non-color data.

When the entire original image pixel byte is D (D>C), the least significant bit of the byte data (one of R, G, and B) of the first pixel of D is compared with the first bit of C.

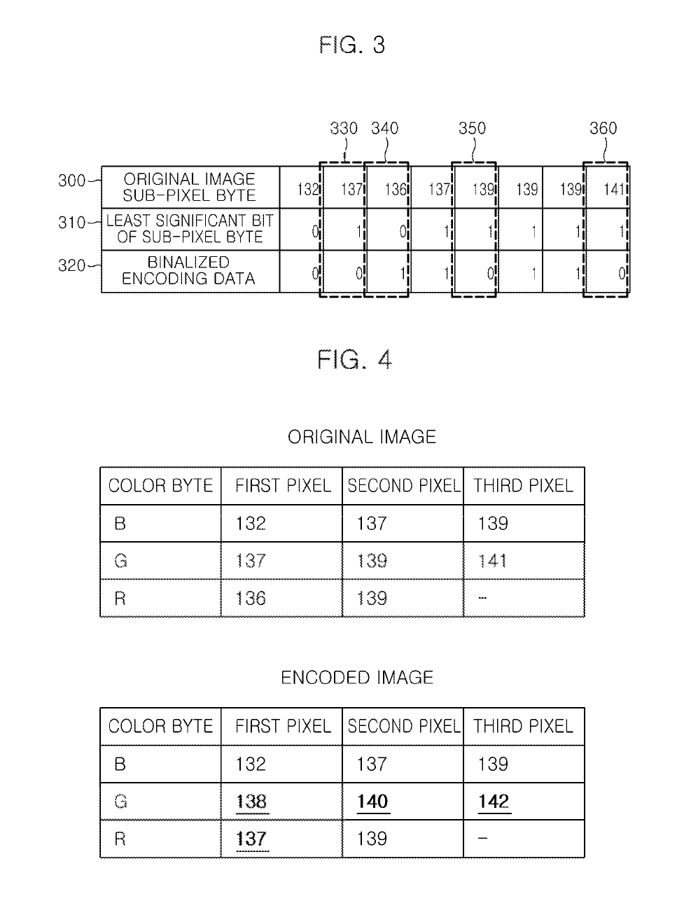

FIG. 3 is a diagram showing the least significant bit (LSB) of byte data of each pixel of the original images and each bit of encoded target data when the first character of a header portion of C is ‘6’.

Referring to FIG. 3, it can be appreciated that the first pixel of the original image, is set to B:132, G:137, and R:136, the second pixel is set to B:137, G:139, and R; 139, and the third pixel is set to B: 139 and G:141.

In other words, the first row 300 of FIG. 3 may be considered as arraying the byte data of each pixel of the original image.

The second row 310 of FIG. 3 represents the LSBs of each byte data. In the example shown in FIG. 3, when the value of the first row 300 is odd, the value of the second row 310 becomes ‘1’ and when the value of the first row 300 is even, the value of the second row 310 becomes ‘0’.

The third row 320 of FIG. 3 represents the value that the first character ‘6’ of the header portion of C is binarized.

In other words, the least significant bits of the byte data of each pixel of the original image are compared with the bit values of each header such that when two values are the same, the pixel value of the original image is maintained and when two bit values are different, the least significant bits of the byte data of the original image pixel is changed.

It can be appreciated from the example shown in FIG. 3 that the least significant bit 1 of the G sub-pixel byte of the first pixel is different from the corresponding bit 0 of the encoding target data (330), the least significant bit 0 of the R sub-pixel byte of the first pixel is different from the corresponding bit 1 of the encoding target data (340), the least significant bit 1 of the G sub-pixel byte of the second pixel is different from the corresponding bit 0 of the encoding target data (350), and the least significant bit 1 of the G sub-pixel byte of the third pixel is different from the corresponding bit 0 of the encoding target data (360).

In the example shown in FIG. 3, the value oldie least significant bit of 8 byte data B, G, R, B, G, R, B, and G is determined by the above-mentioned manner.

Consequently, the pixel value of the encoded image is slightly modified by comparing, with the pixel value of the original image. The byte data of an alpha channel including the R, G, and B sub-pixels and transparency of the pixel can be used according to the original image form.

FIG. 4 is a diagram showing change in image pixels according to is method of encoding haptic information according to one embodiment of the present invention.

Referring to FIG. 4, it can be appreciated that the first pixel of the original image is set to B:132, G:137, and R:136, the second pixel, is set to B:137, G:139, and R:139, and the third pixel is set to B:139 and G:141.

As previously reviewed with reference to FIG. 3, since the least significant bits of the G and R sub-pixel bytes of the first pixel, the G sub-pixel byte of the second pixel, and the G sub-pixel byte of the third pixel are different from the corresponding bits of the encoding, target data, only the LSB of the sub-pixel bytes is changed by +1. For convenience of description. FIG. 4 shows the pixel value is increased by 1. However, it was previously described that the change in the byte data of the pixel is changed in respects to the LSB value.

FIGS. 3 and 4 describes the example where the least significant bit of the byte data is compared with the corresponding bits of the encoding target data but the corresponding bits of the target data may be inserted into the least significant bit of the byte data without performing the comparison process.

It is difficult for a person to visually identify the change and thus, it is difficult to identify the original image and the image encoding the haptic information with the naked eye. Recent research results shows that the change up to last four bits of even bits is not largely cognized by the user.

Therefore, the haptic data may be inserted into a portion of the lower four bits of the byte data but in the present invention, the haptic data may be inserted into the least significant bit of the lower four bits.

The second byte of the haptic data is calculated from R, which is the sub-pixel byte remaining, in the third pixel by the same manner, which is repeated until the encoding of the entire C value of i numbers including the haptic information is completed. The above-mentioned examples describes the case where the sub-pixel bytes are defined by B, G, and R, but the array sequence of the sub-pixel according to the attribute oldie image may have different sequences, such that the description of the embodiment can be changed according to the sequence of the sub-pixel defining the image attribute.

The byte data of the remaining pixels after being encoded is maintained to be the same as that of the original image. In other words, when i haptic information encoding is completed, the byte data of the pixel of m-i images is maintained in the original state.

When a plurality of drivers for the haptic feedback is provided or there are a plurality of controllable elements in terms of characteristics of the drivers, the information should be set by a plurality of channels. This case sets the additional haptic distribution images and writes the information for each channel in the header information, thereby making it possible to store the plurality of haptic distribution information.

Hereinafter, the decoding process will be described when the haptic information is the spatially distributed haptic distribution information.

First, the image having the encoded haptic information is loaded into an application program. In this case, the application program can read the sub-pixel values of each pixel of the loaded image information.

In order to read the header data of the loaded data, the byte data of each pixel are loaded as the array and a new array is generated as the least significant bit of each byte value of the obtained array. The newly generated array is grouped into 8, one byte value per one group is generated to recover the header.

For example, when the value of the first group is equal to “00110110”, it is transformed into a decimal number, which 54. The character set corresponding thereto is obtained based on the ASCII code, thereby making it possible to recover character ‘6’. This process reads the positive integer P having a proper size, which configures one character string. In this case, the positive integer P is for the length of the header information so as to use a very small portion of the entire encoded data and analyze only a portion of the image data, thereby determining the length of the actually encoded haptic information. Only when the length of the actually encoded haptic information should be determined, the decoding process can be efficiently performed.

For example, P can be set to 80 in consideration of binarization in that the character string length of the actual header information is not long, but P can be changed according to the size of the encoded haptic information.

Consequently, only when P is properly determined, the waste of unnecessary resources can be reduced by reading a very small portion of the encoded image when the size of the image data is large. In addition, the meaningful values in data formed like “64_{—}48_{—}1_{—}01_. . . ” can be extracted by using the identifier used at the time of encoding. According to the header format described in the encoding process, the size of the haptic data in the image form has a size of 64×48×1 and the corresponding distribution value represents the depth information including the protrusion information on the surface. In the case of the plurality (two) of maps, the second value represents the temperature value as “64_{—}48_{—}1_{—}01_{—}64_{—}48_{—}1_{—}03 . . . ”

The data region after the determined header information load the byte data corresponding to the haptic data after the header information, extract the LSB from the loaded data set, and are recovered through steps listed in the new array. In order to recover data having 64×48×1, the be data (64×48×1×8) having 64×48×1 are used.

When generating data in the byte form by sequentially grouping the listed array data into 8, the haptic data can be recovered.

When haptic data are recovered, the haptic distribution data image having the defined size (w′×h′) and the defined number of channels are recovered based on the recovered, header information. In addition, the recovered haptic distribution data image is upsized by and has the same size (w×h) as the original image. In the process, the haptic distribution data image can be gray˜scaled if necessary. This is to remove noise in the RGB form that can be generated at the time of the change in size.

The haptic feedback may be provided to the user by using the upsized haptic distribution data. The haptic feedback may be provided at the time of rendering.

The process of providing the haptic feedback can be classified into the case of using the single information and the case of using the array information according to the manner of extracting the information at the position of the cursor on the haptic distribution information extracted through the decoding.

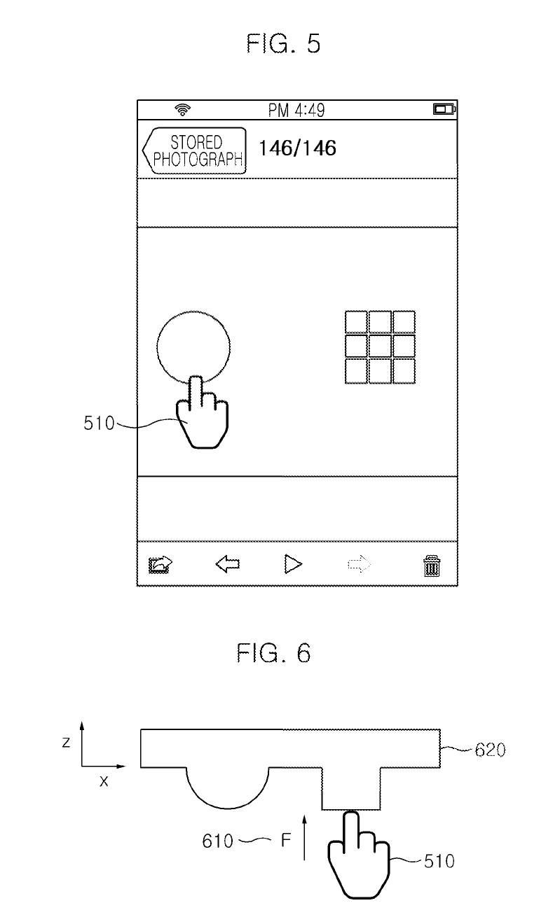

FIG. 5 is a diagram showing as cursor for haptic interaction.

Referring to FIG. 5, it can be appreciated that a cursor 510 for haptic interaction is visually displayed on a monitor.

In general, the cursor for the haptic interaction is generally called a haptic interaction pointer or a haptic interface point (HIP).

It can be appreciated that the image is displayed on the monitor on which the cursor 510 is displayed and the displayed image include the haptic information (depth distribution information). In this case, the haptic distribution information may be upsized.

The cursor 510 can a be moved on the image visually displayed on the monitor while changing the position according to the motion of the user.

In this case, the manner of using the single information is a manner that determines the gray scale, value corresponding to the cursor position on the haptic distribution information extracted by decoding or the single value (v_hip) as an average of the cursor position approximating values and drives the driver using the single value.

On the other hand, the manner of the using the array information performs a step of horizontally dividing the peripheral region of the cursor (HIP) into n partitions and vertically dividing it into m partitions, the cursor being controlled by the haptic arm or a mouse, a positional input device on the image including the haptic distribution information that cannot be visually confirmed by the user to secure the region having a total of n×m parts. In this case, the secured n×m region determines the horizontally and vertically divided number according to the number of drivers. In other words, the manner of using the array information corresponds to the case where the feedback providing apparatus used to generate the haptic feedback is operated through the plurality of inputs.

In this case, the gray scale values in each region are obtained similar to the manner obtaining the representative value such as an average value and an intermediate value for each region. The motion of the drivers is determined according to the values.

For example, when the haptic distribution information is the depth distribution information corresponding to the hemispherical shape acid the hexagonal shape, the peripheral region cursor may be a pixel region that is 30 width×30 breadth in the case where the cursor is positioned at one end of the hemispherical shape.

When the feedback providing apparatus includes the driver of 3 width×3 breadth, the representative value of 3×3 is determined from the peripheral region of the cursor of 30×30. In this case, one representative value may be a representative value for the pixel region of 10×10.

As a result, the provided 3×3 representative value becomes the depth distribution information having less vertical direction protrusion characteristics as going to the hemispherical end and the haptic feedback apparatus provides the haptic feedback to the user by using the depth distribution information.

FIG. 6 is a diagram for explaining haptic distribution information and haptic interaction of a cursor.

Referring to FIG. 6, it can be appreciated that the image displayed on the monitor includes depth distribution information 620 and the haptic feedback is generated according to the relationship between the motion of the cursor 510 and the depth distribution information 620.

For example, if the haptic arm is mounted as the haptic feedback providing apparatus, when the user moves to apply a force 610 to the haptic arm in a depth direction (z-axis), the user feels the reaction force at a different timing according to the depth distribution information and a degree where the objects are protruded. As a result, the user can feel the haptic information as the reaction force against the applied force simultaneously with the visual information.

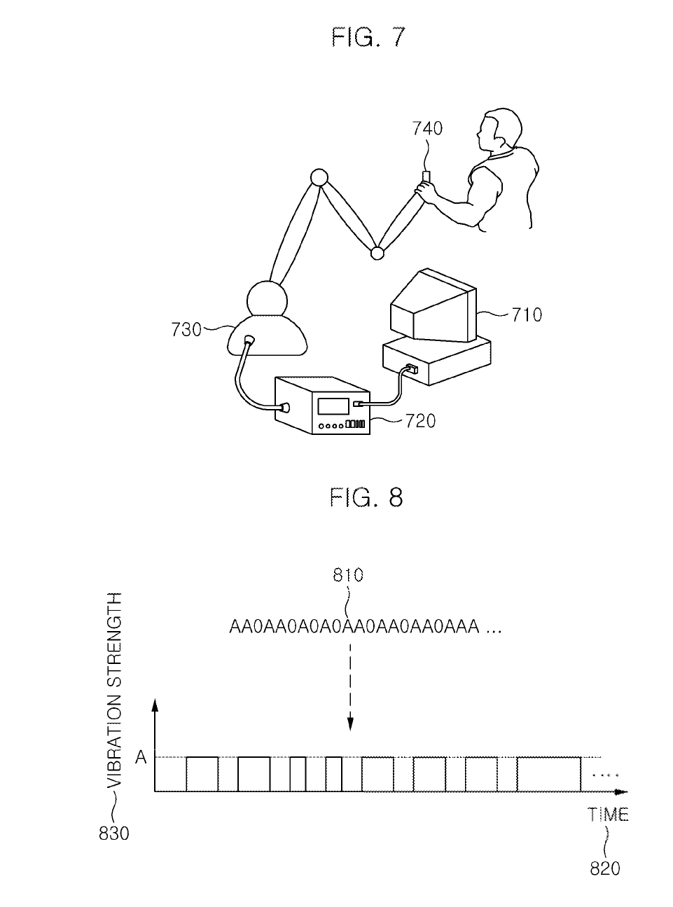

FIG. 7 is a diagram showing one example of haptic feedback presenting apparatus using a haptic arm.

Referring to FIG. 7, the haptic feedback providing apparatus using the haptic arm includes a monitor 710 on which original images are displayed, a controller 720 that drives the haptic arm, a haptic arm system 730, and an end effector 740.

in the example shown in FIG. 7, the reaction force against the force applied by the user is transferred to the user from the end effector 740 of the haptic arm system 730 that is controlled by the controller 720 for driving the haptic arm.

In other words, when the depth direction (z-axis) value of the cursor is HIP_z, the size of the reaction force may be determined as the function of the HIP_z and the gray scale value (v_hip) at the HIP_z of the decoded haptic distribution information, which is called f (v_hip, HIP_z) for convenience sake. As a result, the haptic feedback such as depth, texture, etc., can be transferred to the user.

For example, when the haptic distribution information represents the impedance information, the depth direction (z-axis) speed at the cursor position is HIP_z_vel, the elasticity coefficient is k, and the damping coefficient is b, such that the haptic feedback is determined as the function of f(v_hip, HIP_z_vel, k, b). If necessary, a weight (m) set on the cursor in a virtual environment may be variable of the function.

In the case of the haptic arm, the size and direction of the reaction force determined by the extracted single gray scale value (v_hip) is internally determined and controlled by a combination of values necessary to drive the motors positioned at the articulations of each arm. The control process is called the inverse kinematics of a robot.

When an eccentric, motor, a piezoelectric element, a solenoid, an ultrasonic motor, which generate vibration, are used as the haptic feedback providing apparatus, the haptic feedback provision is performed through the following process.

The cursor (HIP) moves to a point where the user feels touch. This may be executed by the touch input to a portable terminal using a finger or a stylus pen and through the separate interface rather direct contact.

The current/voltage of the driver are determined by the function of the single value (v_hip) that is determined by the gray scale value corresponding to the position of the cursor (HIP) on the haptic distribution information extracted through the decoding process or the average of the approximating values, thereby determining the size or frequency of the vibration stimulus. Generally, the voltage is calculated as effective voltage by the widely known pulse width modulation (PWM). This is a principle that controls the ON/OFF of the motor within the fine time period in order to generate voltage smaller than the applied voltage.

When a peltier device is mounted as the haptic feedback providing apparatus, the haptic feedback provision determines the current/voltage of the driver in response to the function of the single value (v_hip) that is determined by the gray scale value corresponding to the position of the cursor (HIP) on the haptic distribution information extracted through the decoding process or the average of the approximating values, thereby providing warming sense.

In particular, the peltier device determines the cooling or heating of one surface according to the current flowing direction. In this case, the pettier device can use a scheme that determines the current direction according to whether it is a specific threshold value (v_th) or more/or less based on the determined single value (v_hip) and determines the current strength by the function of the absolute value (|v_hip−v_th|) of the difference.

The information extracting scheme in the array form is a scheme that uses the representative gray scale value (v_th[n×m]) of the n×m partition region determined by horizontally dividing the peripheral region of the cursor into n partitions and vertically dividing it into in partitions, the cursor being controlled by using the haptic arm or the mouse, the positional input device on the image including the haptic feedback information, as described above. This scheme is mainly used in the haptic system including the plurality of drivers.

The texture providing apparatus as the haptic feedback apparatus may be an apparatus that controls, for example, the vertically protruded height or the frequency of the vertical protrusion. The contact portion where the texture providing apparatus is applied to the user is controlled to invoke the motion by each driver. For convenience sake, as the degree of shadow of the contact portion approaches white, that is, the gray scale value approaches 255, the driver can be set to invoke the high protrusion.

The user moves the cursor (HIP) on the image including the visually unidentified haptic information by using the mouse etc., the positional input device. That is, the peripheral region of the cursor on the invisible haptic information can be secured. In this case, the peripheral region is horizontally and vertically divided into 3 partitions, such that it may be a region having a total of 9 partitions. In this case, the secured region may be set to be equal to the number of contact portions of the texture providing apparatus.

The representative gray scale values of each region are obtained through the scheme of obtaining the set of representative values such as the average value or intermediate value for each region, such that the dynamic characteristics such as the vertically protruded height of the contactor or the frequency of the vertical protrusion can be determined according to the representative values. By this process, the user can feel the haptic feedback of the depth information or the texture information through the encoded image.

When the pettier device is used as the haptic feedback apparatus, the current/voltage of each driver are determined based on the set of the determined gray scale values (v_hip [9]), thereby controlling the warming sense. In particular, the peltier device determines the cooling or heating of one surface according to the current flowing direction. In this case, the peltier device can use a scheme that determines the current direction according to whether it is a specific threshold value (v_th [9]) or more/or less based on the set of determined single values (v_hip [9]) and determines the current strength of each driver in proportion to the absolute value of the difference.

Hereinafter, the encoding process will be described when the haptic information is the visually distributed information.

As an example of the temporally distributed haptic information, there are beat information or frequency changing information, etc., that have different values over time. If the image includes the temporally distributed haptic information, when the defined time interval is dt, the haptic information value is 0 at the specific time, such that vibration stops during the corresponding period dt, and when the haptic information value has values other than 0 the driver applies current or voltage corresponding to the value, such that driving may be generated. The haptic information may be used for applications that vibrate the portable terminal over time.

FIG. 8 is a diagram showing the example of the haptic information that has values changed over time.

Referring to FIG. 8, it can be appreciated that vibration strength 830 is set over time 820 according to the haptic information 810 having values changed at the predetermined unit time dt.

When the driver is a vibrating motor, it is preferable that it sets dt from several ms to several hundreds ins in consideration of the mechanical response time.

The haptic information 810 that has values changing over time may have the header portion. The header may include the attribute information such as the data length of the portion of the haptic information 810.

For example, when each value of the haptic information 810 is obtained by setting the interval dt to 250 ms and includes a series of 22 values and is generated for two repetitions, the header may be described in a form such as “250_{—}22_{—}2”.

The delimiter such as “_” can be substituted according to its implementation. Moreover, the delimiter may be omitted when a header which has a fixed length is used.

In order to differentiate the spatial distribution data and the haptic information having values changing over time, it can be derived by those skilled in the art that a separate header may be defined.

When the ASCII code values corresponding to each character of the header “250_{—}22_{—}2” is binarized, they are as follows. Blank is added for convenience shake for division and is not included in actual data.

00110010 00110101 00110000 01011111 00110010 00110010 01011111 00110010 01011111

When the exemplified haptic information 810 sets A to 255, it becomes “255 255 0 255 255 0 255 0 255 0 255 255 0 255 255 0 255 255 0 255 255 255”, which can be binarized as follows.

11111111111111110000000011111111111111110000000011111111000000 0011111111000000001111111111111111000000001111111111111111000000001111 11111111111100000000111111111111111111111111

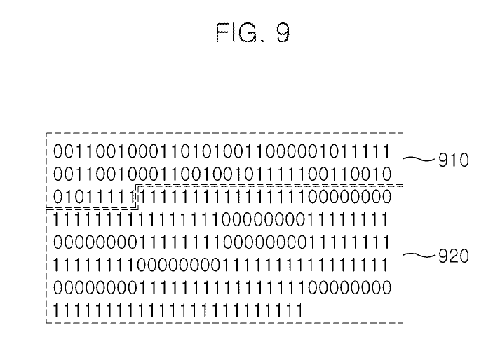

FIG. 9 is a drawings showing an example of the encoding target data when “250_{—}22_{—}2” used as the header and the haptic information of the example shown in FIG. 8 is encoded.

Referring to FIG. 9, it can be appreciated that header information 910 and haptic information 920 are encoded in a series of data form.

A series of bit data shown FIG. 9 are encoded by the original image according to the foregoing manner. In other words, each of a series of bits shown in FIG. 9 is encoded on the LSB of the byte data of the original image pixels.

The user visually confirms the images through haptic information having values changing over time and at the same time, receives the vibration information changing over time like the beat information.

When there are a plurality of drivers for the haptic feedback or the plurality of elements to be controlled in terms of the characteristics oldie driver, the feedback information should be set by the plurality of channels.

The haptic information for the plurality of channels can be easily implemented by writing the number of channels in the header information and writing the additional data identified by the identifier therein.

Hereinafter, the decoding process will be described when the haptic information is the distribution information distributed over time. The temporally distributed haptic information encoded on the image is decoded by the terminal, etc., by using the header information describing the length, attribute, etc., of the haptic information and generates the vibration stimulus based on the tactile stimulus defined in the header.

As the driver generating vibration information, the vibration motor, the piezoelectric element, the solenoid actuator, the ultrasonic motor, etc., can be used.

In the encoding and decoding methods of the forgoing haptic information, when the extension of the original image is “gif”, they include a function of displaying the single image as well as several sheets of images at specific time intervals. The encoding/decoding method of the haptic information according to the present invention can be applied to the animated gif format. In this case, if each image is a frame, the haptic information can be encoded/decoded for each frame similar to the encoding method according to the present invention. In the decoding, however, the haptic feedback can be provided by the haptic information notching the time interval between the images defined in the original animated gif.

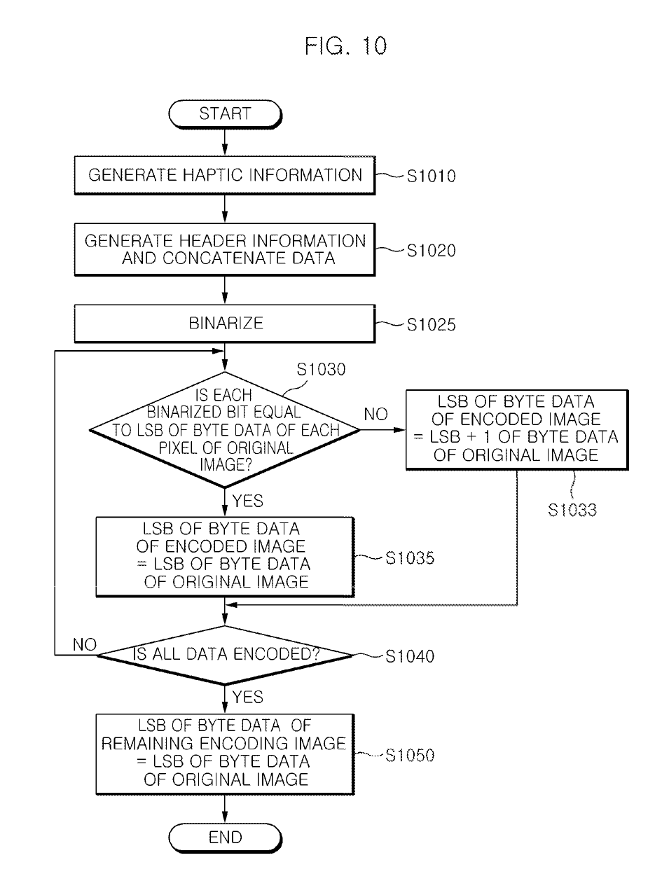

FIG. 10 is an operational flow chart showing the method of encoding the haptic information on the image according to one embodiment of the present invention.

Referring to FIG. 10, the method of encoding the haptic information on the image according to one embodiment first generates the haptic information (S1010).

In this case, the haptic information may be the haptic distribution data of any one of the depth distribution information, the surface impedance distribution information, the temperature distribution information, and the surface texture information all of which are spatially distributed.

In this case, the step (S1010) may generate the haptic information, including the downsizing process of reducing the data size.

In this case, the haptic information may be time series vibration information.

Further, the method of encoding the haptic information, the encoding target data are generated by using the haptic information and the header information associated with the haptic information (S1020).

In other words, step S1020 generates the header information associated with the haptic information and the encoding target data are generated by concatenating the header information with the haptic information.

In addition, the method of encoding the haptic information binarizes the encoding target data (S1025).

In other words, step S1025 binarizes the encoding target data generated at step S1020 to make them into a state to be encoded for each bit.

In addition, the method of encoding the haptic information determines whether each of the binarized bits is equal to the LSB of the byte data of each of the pixel of the original images (S1030).

As the determination result at step S1030, when the binarized bits are equal to the LSB of the byte data of the pixels of the original images, the byte data of the pixels of the original images are maintained as they are (S1035).

As the determination result at step S1030, when the binarized bits are different from the LSB of the byte data of the pixels of the original images, the LSB of the byte data of the pixels of the original images are set to the binarized bit values (S1033).

After step S1035 and step S1033 are performed, the method of encoding the haptic information determines whether all the binarized bit data are encoded (S1040).

As the determination result of step S1040, when all the binarized bit data are not encoded, the method of encoding the haptic information returns to step (S1030) and repeats the encoding process.

As the determination result of step S1040, when all the binarized bit data are encoded, the method of encoding the haptic information maintains the LSBs of the byte data of the remaining pixels of the original images as they are (S1050).

FIG. 10 describes the example where the encoding of the binarized bit data is executed by comparing each of the binarized bits with the LSBs of the byte data of each of the pixels of the original images but the scope of the present invention is not limited to thereto In other words, it is to be construed that all the cases of generating the images encoded by encoding the encoding target data using the least significant bit (LSB) of each of byte data of the image pixels are included in the scope of the present invention.

That is, the encoding of the binarized bit data may insert each bit of the binarized encoding target data into the least significant bit of byte data of each of some pixels of the original image pixels and may maintain the least significant bits of the byte data of the remaining pixels of the original image pixels.

In this case, the byte data of each of the original image pixels may be any one of the R, G, and B sub-pixel byte and the non-color data.

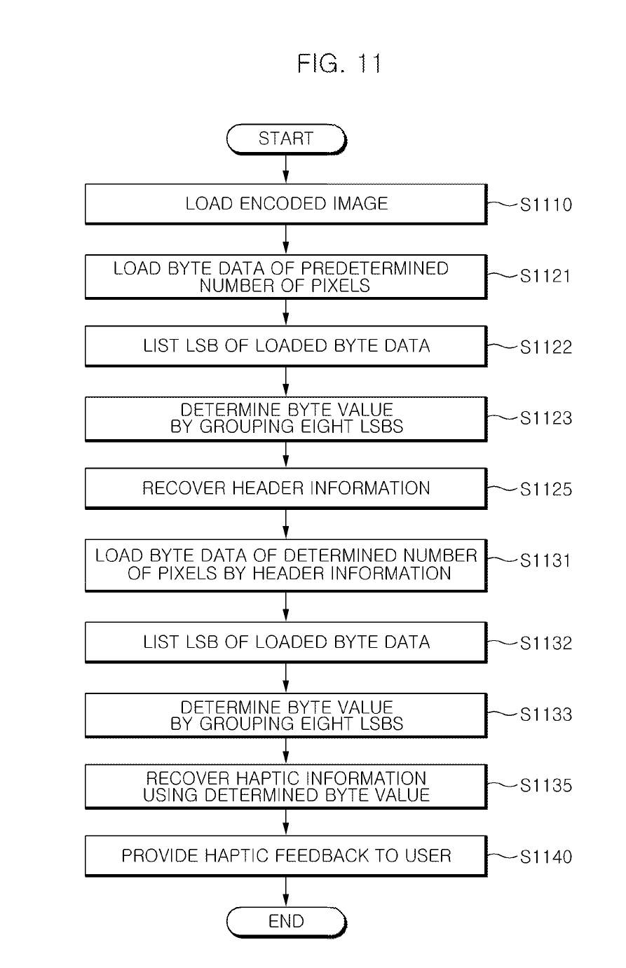

FIG. 11 is an operational flow chart showing the method of decoding the haptic information from the image according to one embodiment of the present invention.

Referring to FIG. 11, the method of decoding the haptic information from the image first loads the encoded image (S1110).

In addition, the method of decoding the haptic information loads the byte data of the predetermined number of pixels from the loaded images (S1121).

In this case, the byte dint may be any one of the R, G, and B sub-pixel byte and the non-color data.

In addition, the method of decoding the haptic information generates the bit stream consisting of the LSBs by listing the LSBs of the loaded byte data (S1122).

Further, the method of decoding the haptic information determines the byte values by grouping the bit stream of the listed LSBs into 8 (S1123).

In addition, the method of decoding the haptic information recovers the header information associated with the haptic information by using the determined byte value (S1125).

In addition, the method of decoding the haptic information loads the byte data of the pixels of the determined number by using the header information among the remaining pixels of the encoded image (S1131).

When the header information is recovered, it can find the attribute and size of the haptic information encoded through the header information and thus, it can accurately determine the number of byte data to be loaded for decoding the haptic information by using the attribute and size of the haptic information.

Further, the method of decoding the haptic information lists the LSBs of the loaded byte data (S1132). In this case, the listed LSBs may include ones that are not used in the header recovery among the listed LSBs at step S1122.

Further, the method of decoding the haptic information determines the byte values by grouping the bit stream of the listed LSBs into 8 (S1133).

In addition, the method of decoding the haptic information recovers the haptic information by using the determined byte value (S1135).

Further, the method of decoding the haptic information provides the haptic feedback to the user by using the header information and the haptic information (S1140).

In this case, the haptic information may be the spatially distributed haptic distribution data. In this case, step S1140 generates the upsized haptic information by upsizing the haptic information and provides the haptic feedback by using the upsized haptic information. Although the resolution of the upsized haptic information is lower than that of the original image, it is difficult for the user to cognize this.

Step S1140 may generate different haptic feedback according to the kind of tactile obtained through the header information.

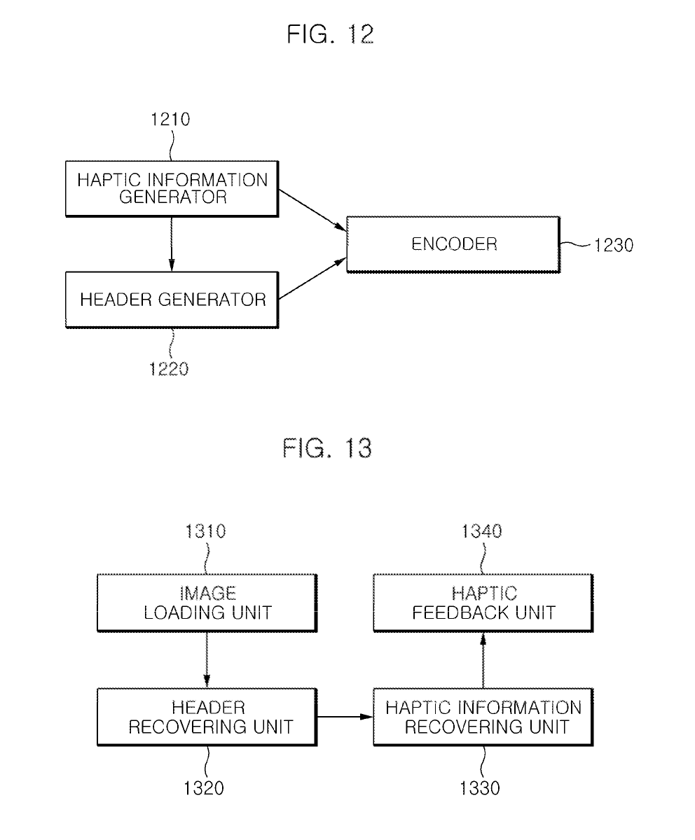

FIG. 12 is a block diagram of an apparatus of processing haptic information according to one embodiment of the present invention.

Referring to FIG. 12, the apparatus for processing, the haptic information according to one embodiment of the present invention includes a haptic information generator 1210, a header generator 1220, and an encoder 1230.

The haptic information generator 1210 generates the haptic information.

In this case, the haptic information is the haptic distribution data and the haptic information generator 1210 may generate the haptic information through the downsizing process of reducing the data size.

The header generator 1220 generates the header information that is associated with the haptic information and consists of the encoding target data together with the haptic information.

The encoder 1230 generates the encoded image by encoding the encoding target data using the least significant bit (LSB) of byte data of each of the original image pixels.

The encoder 1230 may insert each bit of encoding target data into the least significant bit of byte data of each of some pixels of the original image pixels and may maintain the least significant bits of the byte data of the remaining pixels of the original image pixels as they are.

FIG. 13 is a block diagram of an apparatus for processing the haptic information according to another embodiment of the present invention. Referring to FIG. 13, the apparatus for processing the haptic information according to another embodiment of the present invention includes an image loading unit 1310, a header recovering unit 1320, a haptic information recovering unit 1330, and haptic feedback unit 1340.

The image loading unit 1310 loads the encoded image.

The header recovering unit 1320 extracts the least significant bit (13B) of byte data of each of some pixels of the encoded image to recover the header information associated with the haptic information.

In this case, the header recovery unit 1320 can recover the header information by loading the byte data of the predetermined number of pixels, extracting the least significant bits of the loaded byte data, and using the extracted least significant bits.

In this case, the haptic information may be the spatially distributed haptic distribution data, the haptic feedback unit 1340 generates the upsized haptic information by upsizing the haptic information and provide the haptic feedback by using the upsized haptic information.

The haptic information recovering unit 1330 collects the least significant bits of byte data of the predetermined number of byte data by using the header information among the remaining pixels of the encoded image to recover the haptic information.

The haptic feedback unit 1340 provides the haptic feedback to the user by using the header information and the haptic information.

In this case, the haptic feedback unit 1340 may provide the haptic feedback by using the eccentric motor, the piezoelectric element, the solenoid, the ultrasonic motor, the haptic arm, or the texture providing apparatus, etc.

The apparatus for processing the haptic information shown in FIG. 12 corresponds to the haptic information encoder and the apparatus for processing the haptic information shown in FIG. 13 corresponds to the haptic information decoder.

As described above, the method of encoding/decoding the haptic information and the apparatus for processing the haptic information according to the present invention cannot be limited to the configuration and method of the above-mentioned embodiments, but the embodiments may be configured by selectively combining all the embodiments or some of the embodiments so that various modifications can be made.

What is claimed is:

1. A method of encoding haptic information on images, comprising:
generating haptic information;
generating encoding target data by using the haptic information and header information associated with the haptic information; and
generating an encoded image by encoding the encoding target data by using a least significant bit (LSB) of byte data of each of original image pixels.

2. The method of encoding the haptic information on the images according to claim 1, wherein the haptic information is haptic distribution data of any one of depth distribution information including protrusion information, impedance information of a surface, texture distribution information, and temperature distribution information all of which are spatially distributed.

3. The method of encoding the haptic information on the images according to claim 2, wherein the generating the haptic information includes a downsizing process of reducing a data size to generate the haptic information.

4. The method of encoding the haptic information on the images according to claim 1, wherein the haptic information is time series vibration information.

5. The method of encoding the haptic information on the images according to claim 1, wherein the generating the encoded image inserts each bit of the encoding target data into the least significant bit of byte data of each of some pixels of the original image pixels and originally maintains the least significant bits of the byte data of each of the remaining pixels of the original image pixels.

6. The method of encoding the haptic information on the images according to claim 5, wherein the byte data of each of the original image pixels are any one of R, G, and B sub-pixel bytes and non-color data.

7. The method of encoding the haptic information on the images according to claim 6, wherein when the original image is an animated gif file, the encoding target data is encoded in each image frame.

8. A method of decoding haptic information from images, comprising:
loading an encoded image;
extracting least significant bits (LSBs) of byte data of each of some pixels of the encoded image to recover header information associated with haptic information; and
collecting the least significant bits of byte data of the determined number of pixels by using the header information to recover the haptic information.

9. The method of decoding the haptic information from the images according to claim 8, further comprising providing haptic feedback to a user by using the header information and the haptic information.

10. The method of decoding the haptic information from the images according to claim 9, wherein the extracting the header information loads byte data of a predetermined number of pixels to extract the least significant bits of the loaded byte data and recover the header information by using the extracted bits.

11. The method of decoding the haptic information from the images according to claim 10, wherein the haptic information is spatially distributed haptic distribution data and the providing the haptic feedback upsizes the haptic information to generate the upsized haptic information and uses the upsized haptic information to provide the haptic feedback.

12. The method of decoding the haptic information from the images according to claim 9, wherein the byte data of each of the pixels of the encoded image are any one of R, G, and B sub-pixel bytes and non-color data.

13. An apparatus of processing haptic information, comprising:
a haptic information generator that generates haptic information;
a header generator that is associated with the haptic information and configures encoding target data together with the haptic information; and
an encoder that encodes the encoding target data by using a least significant bit (LSB) of byte data of each of original image pixels to generate art encoded image.

14. The apparatus of processing haptic information according to claim 13, wherein the haptic information is haptic distribution data and the haptic information generator generates the haptic information by a downsizing process of reducing a data size.

15. The apparatus of processing haptic information according to claim 13, wherein the encoder inserts each bit of the encoding target data into the least significant bit of byte data of each of some pixels of the original image pixels and originally maintains the least significant bits of the byte data of the remaining pixels of the original image pixels.

16. An apparatus of processing haptic information, comprising:
an image loading unit that loads an encoded image;
a header recovering unit that extracts least significant bits (LSBs) of each byte data of some pixels of the encoded image to recover header information associated with haptic information; and
a haptic information recovering unit that collects the least significant bits of byte data of the determined number of pixels by using the header information to recover the haptic information.

17. The apparatus of processing haptic information according to claim 16, further comprising a haptic feedback unit that uses the header information and the haptic information to provide the haptic feedback to a user.

18. The apparatus of processing haptic information according to claim 17, wherein the header recovering unit loads the byte data of a predetermined number of pixels, extracts the least significant bits of loaded byte data, and uses the extracted least significant bits to recover the header information.

19. The apparatus of processing haptic information according to claim 17, wherein the haptic information is spatially distributed haptic distribution data and the haptic feedback unit upsizes the haptic information to generate the upsized haptic information and uses the upsized haptic information to provide the haptic feedback.

20. The apparatus of processing haptic information according to claim 17, wherein the haptic feedback unit uses any one of an eccentric motor, a piezoelectric element, a pettier device, a solenoid, an ultrasonic motor, a haptic arm, and a texture providing apparatus to provide the haptic feedback.
